(19) United States
(12) Patent Application Publication
(10) Pub. No.: US 2004/0205776 A1
(43) Pub. Date: Oct. 14, 2004

(54) Method and apparatus for concurrent update and activation of partition firmware on a logical partitioned data processing system

(75) Inventors: Bradley Ryan Harrington, Austin, TX (US); Stephen Dale Linam, Austin, TX (US); Vikramjit Sethi, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/411,465

(22) Filed: Apr. 10, 2003

(51) Int. Cl. G06F 9/00

(52) U.S. Cl. 719/320

(57) ABSTRACT

A method, apparatus, and computer instructions for updating partition firmware in a logical partitioned data processing system. A first module in the partition firmware for a partition within a set of partitions is loaded. The first module provides an interface for receiving calls from an operating system in the partition. A second module in the partition firmware for the partition is loaded. The second module is loaded by the first module, and the second module provides a plurality of functions. Calls received at the interface of the first module are routed to the second module. The second module executes functions in response to the calls. A new second module may be loaded while the original second module continues to execute. Thereafter, the new second module may begin execution with the original second module being terminated.

### BACKGROUND OF THE INVENTION

1. Technical Field

The present invention relates generally to an improved data processing system, and in particular to an improved method and apparatus for managing processes on a data processing system. Still more particularly, the present invention relates to an improved method, apparatus, and computer instructions for managing partition firmware in a logical partitioned data processing system.

2. Description of Related Art

A logical partitioned (LPAR) functionality within a data processing system (platform) allows multiple copies of a single operating system (OS) or multiple heterogeneous operating systems to be simultaneously run on a single data processing system platform. A partition, within which an operating system image runs, is assigned a non-overlapping subset of the platform's resources. These platform allocable resources include one or more architecturally distinct processors with their interrupt management area, regions of system memory, and input/output (I/O) adapter bus slots. The partition's resources are represented by the platform's firmware to the operating system image.

Each distinct operating system or image of an operating system running within the platform is protected from each other such that software errors on one logical partition cannot affect the correct operation of any of the other partitions. This is provided by allocating a disjoint set of platform resources to be directly managed by each operating system image and by providing mechanisms for ensuring that the various images cannot control any resources that have not been allocated to it. Furthermore, software errors in the control of an operating system's allocated resources are prevented from affecting the resources of any other image. Thus, each image of the operating system (or each different operating system) directly controls a distinct set of allocable resources within the platform.

With respect to hardware resources in a LPAR data processing system, these resources are disjointly shared among various partitions, themselves disjoint, each one seeming to be a stand-alone computer. These resources may include, for example, input/output (I/O) adapters, memory dimms, nonvolatile random access memory (NVRAM), and hard disk drives. Each partition within the LPAR data processing system may be booted and shutdown over and over without having to power-cycle the whole system.

In a LPAR data processing system, the different partitions have firmware, which is used in conjunction with the operating systems in the partitions. In other words, each partition includes partition firmware that operates in conjunction with the operating system in the partition. Currently, updates to partition firmware require rebooting the LPAR data processing system. In many cases, these systems are used as servers for various web or Internet applications. Rebooting the LPAR data processing system may interrupt services being provided to various users.

Therefore, it would be advantageous to have an improved method, apparatus, and computer instructions for updating partition firmware.

### SUMMARY OF THE INVENTION

The present invention provides a method, apparatus, and computer instructions for updating partition firmware in a logical partitioned data processing system. A first module in the partition firmware for a partition within a set of partitions is loaded. The first module provides an interface for receiving calls from an operating system in the partition. A second module in the partition firmware for the partition is loaded. The second module is loaded by the first module, and the second module provides a plurality of functions. Calls received at the interface of the first module are routed to the second module. The second module executes functions in response to the calls. A new second module may be loaded while the original second module continues to execute. Thereafter, the new second module may begin execution with the original second module being terminated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein;

FIG. 1 is a block diagram of a data processing system in which the present invention may be implemented;

FIG. 2 is a block diagram of an exemplary logical partitioned platform in which the present invention may be implemented;

FIG. 3 is a diagram illustrating a partition firmware in accordance with a preferred embodiment of the present invention;

FIG. 4 is a flowchart of a process for loading partition firmware in accordance with a preferred embodiment of the present invention;

FIG. 5 is a flowchart of a process for routing calls in accordance with a preferred embodiment of the present invention; and

FIG. 6 is a flowchart of a process for updating or reconfiguring partition firmware in accordance with a preferred embodiment of the present invention.

### DETAILED DESCRIPTION OF THE PREFERRED EMBODIMENT

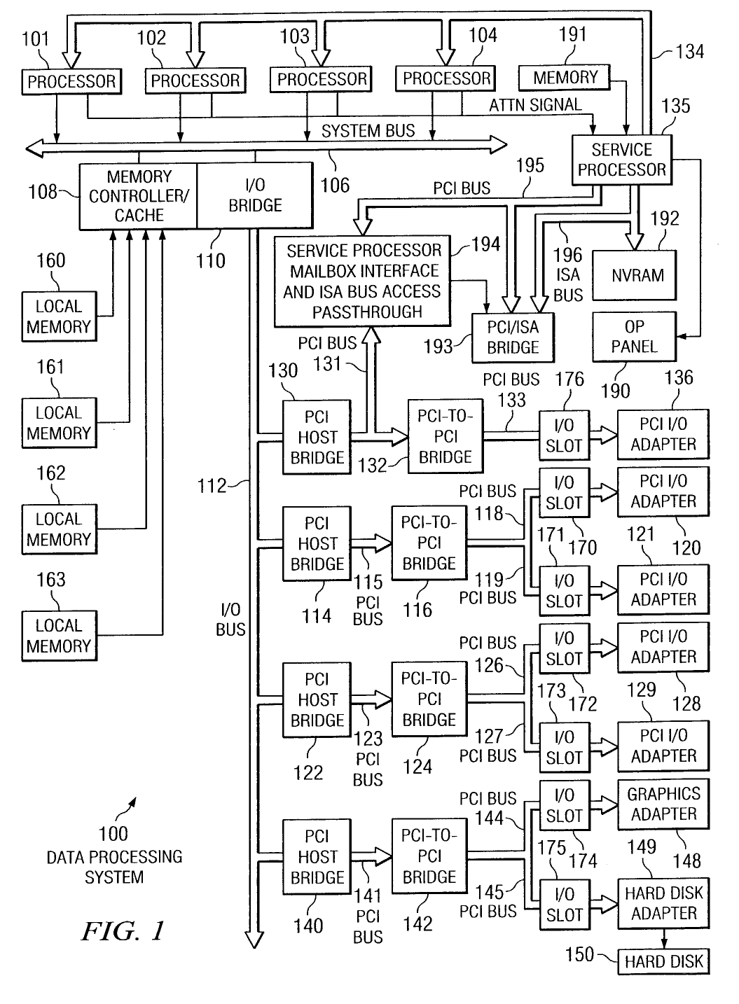

With reference now to the figures, and in particular with reference to FIG. 1, a block diagram of a data processing system in which the present invention may be implemented is depicted. Data processing system 100 may be a symmetric multiprocessor (SMP) system including a plurality of processors 101, 102, 103, and 104 connected to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and each of local memories 160-163 is assigned to one of the three partitions. For example, processor 101, local memory 160, and I/O adapters 120, 128, and 129 may be assigned to logical partition P1; processors 102-103, local memory 161, and PCI I/O adapters 121 and 136 may be assigned to partition P2; and processor 104, local memories 162-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Windows XP operating system may be operating within logical partition P1. Windows XP is a product and trademark of Microsoft Corporation of Redmond, Wash.

Peripheral component interconnect (PCI) host bridge 114 connected to I/O bus 112 provides an interface to PCI local bus 115. A number of PCI input/output adapters 120-121 may be connected to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations will support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 is connected to a plurality of PCI I/O adapters 128-129. PCI I/O adapters 128-129 may be connected to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. In this manner, data processing system 100 allows connections to multiple network computers.

A memory mapped graphics adapter 148 inserted into I/O slot 174 may be connected to I/O bus 112 through PCI bus 144, PCI-to-PCI bridge 142, PCI bus 141 and PCI host bridge 140. Hard disk adapter 149 may be placed into I/O slot 175, which is connected to PCI bus 145. In turn, this bus is connected to PCI-to-PCI bridge 142, which is connected to PCI host bridge 140 by PCI bus 141.

A PCI host bridge 130 provides an interface for a PCI bus 131 to connect to I/O bus 112. PCI I/O adapter 136 is connected to I/O slot 176, which is connected to PCI-to-PCI bridge 132 by PCI bus 133. PCI-to-PCI bridge 132 is connected to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips 12C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases the host processors 101-104 for execution of the code loaded into local memory 160-163. While the host processors 101-104 are executing code from respective operating systems within the data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using as an AIX or LINUX operating system.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

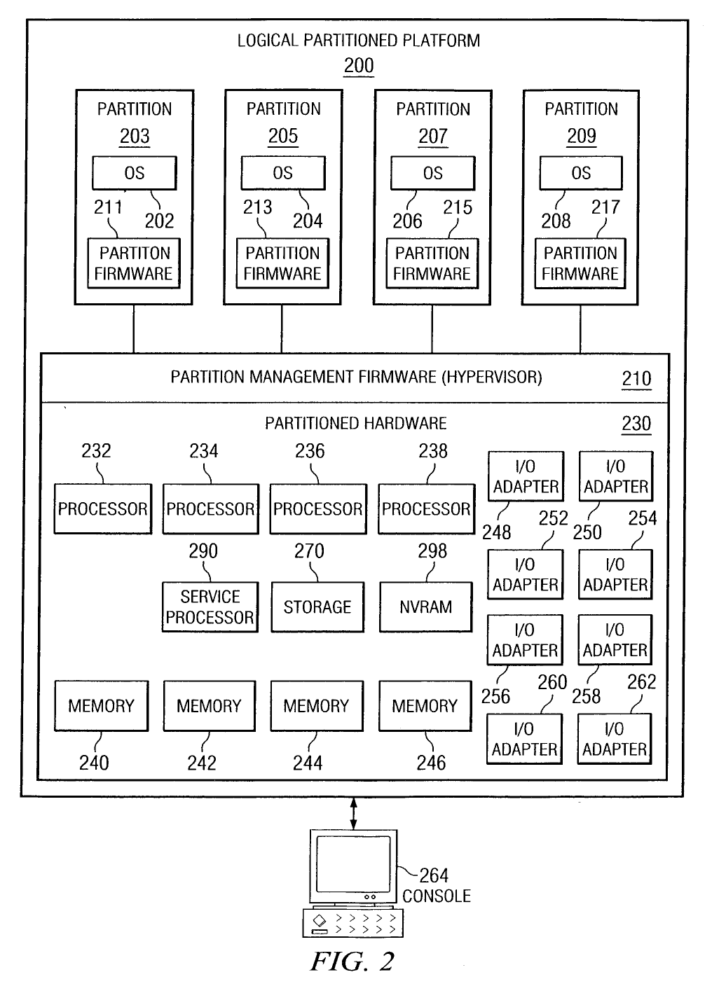

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and hypervisor 210. Operating systems 202, 204, 206, and 208 may be multiple copies of a single operating system or multiple heterogeneous operating systems simultaneously run on platform 200. These operating systems may be implemented using AIX or LINUX, which are designed to interface with a hypervisor. Operating systems 202, 204, 206, and 208 are located in partitions 203, 205, 207, and 209.

Additionally, these partitions also include partition firmware (PFW) 211, 213, 215, and 217. Partition firmware provides functions that may be called by the operating system in the partition. When partitions 203, 205, 207, and 209 are instantiated, a copy of the partition firmware is loaded into each partition by the hypervisor's partition manager. The processors associated or assigned to the partitions are then dispatched to the partition's memory to execute the partition firmware. This partition firmware includes open firmware and runtime abstraction services (RTAS). Partition firmware is currently packaged in a single module or load identifier (LID). With the present invention, the runtime function of the partition firmware may be reloaded while a partition is running without rebooting that partition. Having partition firmware placed into more than LID as well as adding additional functions allows for such a feature. The present invention provides a mechanism in which two separate loadable modules are provided for the partition firmware in a manner that allows for firmware updates to occur without rebooting platform 200. Such a feature reduces interruption in execution of various applications. In these examples, LIDs are used as a container for an independently-loaded module in flash memory. The mechanism of the present invention, however, may be implemented using any format that supports more than one independently-loadable module.

Partitioned hardware 230 includes a plurality of processors 232-238, a plurality of system memory units 240-246, a plurality of input/output (I/o) adapters 248-262, and a storage unit 270. Partitioned hardware 230 also includes service processor 290, which may be used to provide various services, such as processing of errors in the partitions. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware (hypervisor) 210 performs a number of functions and services for partitions 203, 205, 207, and 209 to create and enforce the partitioning of logical partitioned platform 200. Hypervisor 210 is a firmware implemented virtual machine identical to the underlying hardware. Hypervisor software is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM). Thus, hypervisor 210 allows the simultaneous execution of independent OS images 202, 204, 206, and 208 by virtualizing all the hardware resources of logical partitioned platform 200.

Operations of the different partitions may be controlled through a hardware management console, such as console 264. Console 264 is a separate data processing system from which a system administrator may perform various functions including reallocation of resources to different partitions.

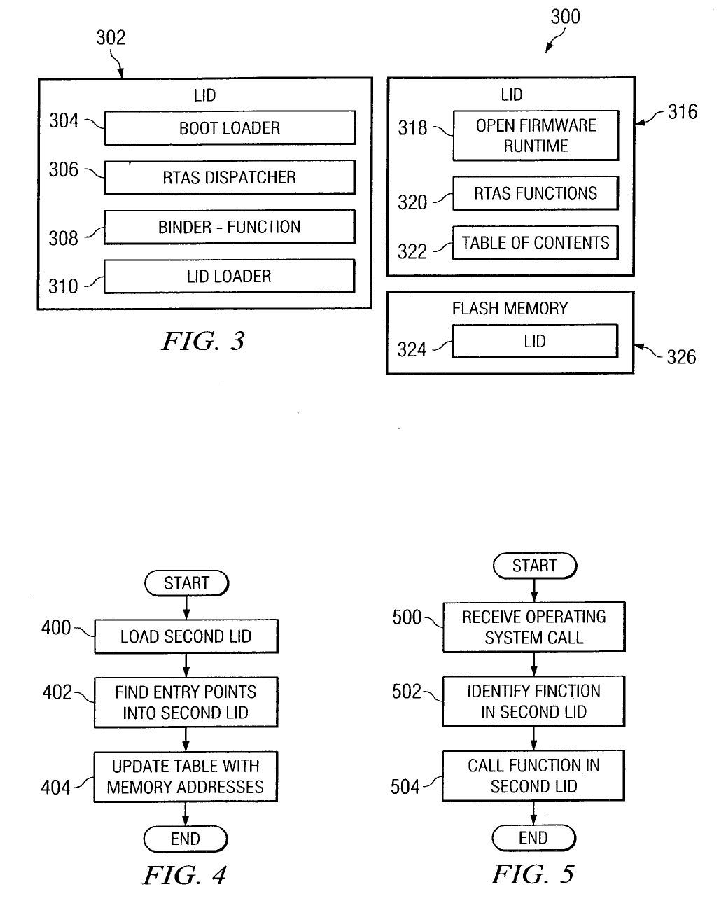

Turning next to FIG. 3, a diagram illustrating a partition firmware is depicted in accordance with a preferred embodiment of the present invention. Partition firmware 300 may be implemented in platform 200 as partition firmware 211, 213, 215, or 217 in FIG. 2. In these examples, partition firmware 300 is implemented as two separately loadable modules or load identifiers (LIDS). Such a configuration is in contrast to the currently structured single LID systems.

LID 302 is the fixed part of partition firmware 300. This module is loaded into memory by hypervisor, such as the one illustrated in FIG. 2. LID 302 is the fixed part of partition firwmare 300. This module is loaded into memory by hypervisor, such as the one ilustrated in FIG. 2. LID 302 includes boot loader 304, RTAS dispatcher 306, binder function 308, LID loader function 310, and open firmware function 312. Boot loader 304 is used to set up stacks to establish an environment in which open firmware function 312 can execute. The LID loader function 310 is used to load the second runtime LID 316 into memory. Binder function 308 is used to examine the table of contents 322 to determine the addresses of RTAS and open firmware functions, which is used to update a dispatch table in the RTAS dispatcher 306. More specifically, the RTAS dispather 306 contains a data structure which associates each RTAS function that can be called by the partition operating system, identified by an RTAS token, with the address of an implementing function; the binder function 308 locates the address of each implementing function and fills in this table with the appropriate address.

In partition firmware 300, LID 316 includes open firmware runtime 318, RTAS functions 320, and table of contents 322. As can be seen, the open firmware runtime component and RTAS code is located in LID 316. This open firmware runtime and RTAS code provides various functions that may be called by an operating system in the partition in which this partition firmware executes. Table of contents 322 provides global symbols, as well as other information used to set up function pointers to the different functions provided by open firmware runtime 318 and RTAS functions 320 in LID 316. RTAS functions are provided to insulate the operating system from having to manipulate a number of important platform functions which would otherwise require platform-dependent code in the operating system. Examples of these functions are reading and writing NVRAM, reading and setting the time of day, recognizing and reporting platform hardware errors, reading and writing PCI configuration space, reading or writing interrupt configuration registers, and many more.

LID 316 is designed to be dynamically replaceable or updated in response to a call being made to activate-firmware RTAS function 314.

At partition boot, LID 302 is loaded, which in turn loads LID 316, using LID loader function 310. Thereafter, LID 302 also sets up stacks and examines table of contents 322 to find locations of global symbols and to set up function pointers in RTAS dispatcher 306 using binder function 308. Further, a function pointer will be set to jump to the starting point of open firmware runtime 318 in LID 316. In addition, RTAS global data is stored in association with LID 302. Once the function pointers have been set up, RTAS dispatcher 306 will route calls from the operating system to the appropriate functions in LID 316. Usually global variables are accessed by finding an address in the modules' table of contents (TOC). With the present invention providing a mechanism for replacing a module, including the TOC, this scheme will not work. Moreover, storage for the global data is also within the module, and the current “state” is lost when the module is replaced. This problem is solved by storing all global data used by the run-time LID 316 inside the fixed LID 302, an instead of accessing variable directly (through the TOC) data is stored in the fixed LID 302 and accessed through data encapsulation methods. The encapsulation methods work by keeping a single anchor pointer inside of the fixed LID and by maintaining a table of contents (different from the module's TOC) which is used to locate each data time relative to the anchor pointer.

The mechanism of the present invention allows for a firmware update to be performed for partition firmware 300 in a manner that does not require rebooting of the partition or LPAR data processing system. The process of updating firmware is initiated by the hardware management console (HMC) which replaces LID 316 in flash memory with a new version and then sends a message to the operating system in each partition indicating that the operating system should begin the process of activating the new firmware. The operating system begins the process of activating the new firmware by calling an RTAS activate-firmware service. This RTAS service loads the new copy of LID 316 into memory. This new copy of the second LID is an updated set of functions in this example. The new copy of LID 316 does not overlay the copy of LID 316 that is currently in use. The process of loading the new copy of LID 316 may take some time to complete, and while it is in process the activate-firmware service may return and allow other RTAS functions to be called by the operating system. The operating system continues to call the RTAS activate-firmware service at regular intervals until it is complete. After the new LID is loaded, function pointers are set up for LID 324, as with LID 316.

Specifically, entry points in the new LID are identified using the binder function 308. With these entry points, the RTAS dispatcher 306 is updated with the new entry points. At this point, the activation process is complete and the RTAS activate-firmware service returns a return code that indicates this. The process of serializing the update of function pointers to reference the new copy of LID 316 is accomplished because the semantics of making RTAS calls require that an operating system make only one RTAS function call at a time. Thus, while the RTAS call is in the process of updating the function pointers, there will not be another RTAS call received that would require the RTAS dispatcher 306 to use the function table.

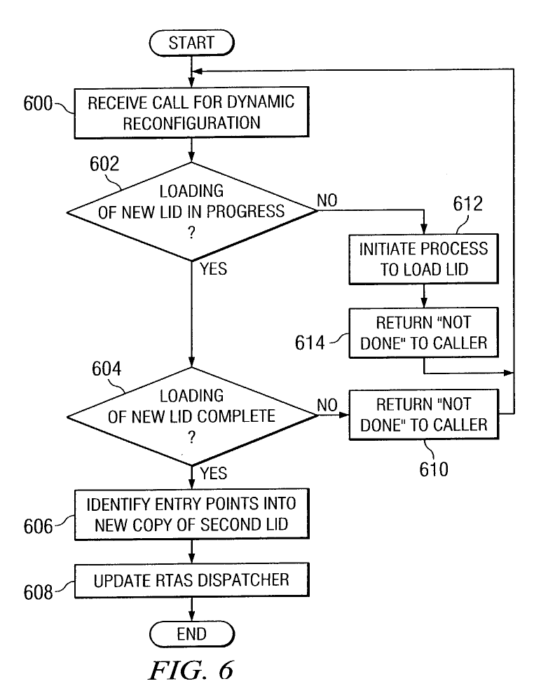

Note that the process of reloading and activating LID 316 at runtime is almost identical to the steps done at boot time. In a preferred embodiment the same code instructions would be used to perform these steps at boot time (shown in FIG. 4) and during run-time activation (illustrated in FIG. 6).

Turning now to FIG. 4, a flowchart of a process for loading partition firmware is depicted in accordance with a preferred embodiment of the present invention. The process illustrated in FIG. 4 is performed by a LID, such as LID 302 in FIG. 3. This process is initiated after this first LID in the partition firmware is loaded into the partition.

The process begins by loading the second LID (step 400). Thereafter, entry points into the second LID are identified (step 402). These entry points are those into open firmware and functions that may be called by an operating system. With these entry points, a table of memory addresses is updated for a RTAS dispatcher (step 404), with the process terminating thereafter. These memory addresses are used by the RTAS dispatcher to route calls received from the operating system to the appropriate functions in the second LID.

Turning now to FIG. 5, a flowchart of a process for routing calls is depicted in accordance with a preferred embodiment of the present invention. The process illustrated in FIG. 5 is implemented in a dispatcher, such as RTAS dispatcher 306 within LID 302 in FIG. 3.

The process begins by receiving an operating system call for a function (step 500). Thereafter, a function is identified in the second LID (step 502). This function is identified using memory addresses for different entry points for various functions in the second LID. After the appropriate entry point is located for the call, the function in the second LID is called (step 504), with the process terminating thereafter.

With reference now to FIG. 6, a flowchart of a process for updating or reconfiguring partition firmware is depicted in accordance with a preferred embodiment of the present invention. The process illustrated in FIG. 6 may be implemented in an update function.

The process begins by receiving a call for dynamic reconfiguration (step 600). In response to receiving this call, a determination is made as to whether loading of the new LID is in progress (step 602). If loading of the new LID is in progress, a determination is made as to whether the loading has completed (step 604). If loading of the new LID has completed, entry points into this new copy of the second LID are identified (step 606). The RTAS dispatcher is then updated with these new addresses for the entry points (step 608), with the process terminating thereafter.

With reference again to step 604, if the loading of the new LID has not completed, a message “not done” is returned to the caller (step 610), with the process then returning to step 600 as described above. Turning back to step 602, if the loading of the new LID is not in progress, a process initiated to load this new LID (step 612), and a message “not done” is returned to the caller (step 614), with the process returning to step 600 thereafter.

The mechanism of the present invention allows for partition firmware updates to be made in the same way that a dynamic reconfiguration operation normally occurs for an operating system. When this dynamic configuration is requested, the mechanism of the present invention performs an update of the partition firmware without requiring rebooting of the partition or the LPAR data processing system.

In this manner, the present invention provides a method, apparatus, and computer instructions for updating and activating partition firmware in a manner that does not require rebooting of the system. With this feature, interruption of applications running on the LPAR data processing system and interruptions to services provided to users of those applications are minimized. The present invention provides these advantages, as well as other advantages, through the use of two LIDS. The first LID loads the second LID and also provides a mechanism to route calls to the second LID as well as update or replace the second LID with a new one.

The various functions provided are located in the second LID in these examples. Of course, some of the functions may be provided in the first LID. Such an arrangement, however, does not allow for updating of those functions located in the first LID. Further, although only one secondary LID containing the functions is located, a mechanism of the present invention may be implemented so that multiple second LIDs are employed. With multiple second LIDs, entry points are located for the functions in these different LIDs with the dispatcher then being updated with the appropriate entry points.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for updating partition firmware in a logical partitioned data processing system, the method comprising:
loading a first module in the partition firmware for a partition within a set of partitions, wherein the first module provides an interface for receiving calls from an operating system in the partition;
loading a second module in the partition firmware for the partition, wherein the second module is loaded by the first module and wherein the second module provides a plurality of functions; and
routing calls received at the interface of the first module to the second module, wherein the second module executes functions in response to the calls.

2. The method of claim 1, wherein the first module and the second module are load identifiers.

3. The method of claim 1, wherein the first module identifies function entry points in the second module and updates a function table with memory addresses for the function entry points to route calls received at the interface of the first module to the second module.

4. The method of claim 1, wherein the second module is an original second module and further comprising:
responsive to a request to update the partition firmware, loading a new second module while the original second module continues to operate; and
routing calls to the new second module, wherein the partition firmware is dynamically updated without requiring rebooting of the partition.

5. The method of claim 4, wherein the step of routing calls the new second module comprises:
identifying function entry points in the new second module; and
updating a function table with memory addresses for the function entry points to route calls received at the interface of the first module to the new second module.

6. The method of claim 1, wherein the request is a request for a dynamic reconfiguration of the partition firmware.

7. The method of claim 1, wherein the routing step is performed by a function dispatcher in the first module.

8. A logical partitioned data processing system, the logical partitioned data processing system method comprising:
first loading means for loading a first module in the partition firmware for a partition within a set of partitions, wherein the first module provides an interface for receiving calls from an operating system in the partition;
second loading means for loading a second module in the partition firmware for the partition, wherein the second module is loaded by the first module and wherein the second module provides a plurality of functions; and
routing means for routing calls received at the interface of the first module to the second module, wherein the second module executes functions in response to the calls.

9. The logical partitioned data processing system of claim 8, wherein the first module and the second module are load identifiers.

10. The logical partitioned data processing system of claim 8, wherein the first module identifies function entry points in the second module and updates a function table with memory addresses for the function entry points to route calls received at the interface of the first module to the second module.

11. The logical partitioned data processing system of claim 8, wherein the second module is an original second module and further comprising:
third loading means, responsive to a request to update the partition firmware, for loading a new second module while the original second module continues to operate; and
second routing means for routing calls to the new second module, wherein the partition firmware is dynamically updated without requiring rebooting of the partition.

12. The logical partitioned data processing system of claim 11, wherein the routing second routing means comprises:
identifying means for identifying function entry points in the new second module; and
updating means for updating a function table with memory addresses for the function entry points to route calls received at the interface of the first module to the new second module.

13. The logical partitioned data processing system of claim 8, wherein the request is a request for a dynamic reconfiguration of the partition firmware.

14. The logical partitioned data processing system of claim 8, wherein the routing means is located in a function dispatcher in the first module.

15. A logical partitioned data processing system comprising:
a bus system;
a memory connected to the bus system, wherein the memory includes a set of instructions;
a processing unit having a plurality of processors and being connected to the bus system, wherein the processing unit executes the set of instructions to load a first module in the partition firmware for a partition within a set of partitions, wherein the first module provides an interface for receiving calls from an operating system in the partition; load a second module in the partition firmware for the partition, wherein the second module is loaded by the first module and wherein the second module provides a plurality of functions; and route calls received at the interface of the first module to the second module, wherein the second module executes functions in response to the calls.

16. A computer program product in a computer readable medium for updating partition firmware in a logical partitioned data processing system, the computer program product comprising:
first instructions for loading a first module in the partition firmware for a partition within a set of partitions, wherein the first module provides an interface for receiving calls from an operating system in the partition;
second instructions for loading a second module in the partition firmware for the partition, wherein the second module is loaded by the first module and wherein the second module provides a plurality of functions; and
third instructions for routing calls received at the interface of the first module to the second module, wherein the second module executes functions in response to the calls.

17. The computer program product of claim 16, wherein the first module and the second module are load identifiers.

18. The computer program product of claim 16, wherein the first module identifies function entry points in the second module and updates a function table with memory addresses for the function entry points to route calls received at the interface of the first module to the second module.

19. The computer program product of claim 16, wherein the second module is an original second module and wherein the set of instructions further comprises:
fourth instructions, responsive to a request to update the partition firmware, for loading a new second module while the original second module continues to operate; and
fifth instructions for routing calls to the new second module, wherein the partition firmware is dynamically updated without requiring rebooting of the partition.

20. The data processing system of claim 19, wherein the fifth instructions for routing calls, the new second module comprises:
first sub-instructions for identifying function entry points in the new second module;
second sub-instructions for updating a function table with memory addresses for the function entry points to route calls received at the interface of the first module to the new second module.
